(19) United States
(12) Patent Application Publication
(10) Pub. No.: US 2011/0017748 A1
(43) Pub. Date: Jan. 27, 2011

(54) LIQUID FUEL STORAGE TANK FOR AUTOMOTIVE VEHICLE

(75) Inventors: Rodolfo Palma, Canton, MI (US); Mike Dong, Ann Arbor, MI (US); Mohammad Usman, Northville, MI (US)

Correspondence Address: Jerome R. Drouillard, 10213 Tims Lake Blvd., Grass Lake, MI, 49240, US

(73) Assignee: Ford Global Technologies, LLC, Dearborn, MI (US)

(21) Appl. No.: 12/508,639

(22) Filed: Jul. 24, 2009

(51) Int. Cl. B60P 3/22; B65D 90/52

(52) U.S. Cl. 220/562; 220/734

(57) ABSTRACT

A fuel storage tank for an automotive vehicle includes a receiver with a number of perimeter walls defining an interior volume for storing liquid fuel. A number of anti-slosh bodies are located within the receiver. A locator structure cooperates with perimeter walls to confine the anti-slosh bodies within a predetermined part of the interior volume.

### BACKGROUND OF THE DISCLOSURE

1. Field of the Disclosure

The present disclosure relates to a liquid transportation tank, and more particularly to a fuel storage tank for an automotive vehicle.

2. Related Art

Because fuel inside an automotive liquid fuel tank moves freely, or, in the colloquial, “sloshes” while a vehicle is moving, undesirable noise and fuel pump starvation may occur, particularly when the fuel level is low. Fuel sloshing may also cause problems with fuel level indicating devices, and in extreme cases may cause unacceptably rapid deterioration of internal tank components and exterior mounting devices, such as straps. Although internal baffles have been used in fuel tanks for years, such baffles are difficult to secure, particularly in the case of plastic fuel tanks. And, baffles generally exhibit poor performance and are expensive to design and tool for each tank. Moreover, many of these problems are typically found with other types of tanks used to transport liquids.

It would be desirable to provide a tank, such as a fuel tanks, in which liquid sloshing is controlled with a system which is compatible with both metal and plastic tanks.

### SUMMARY OF THE DISCLOSURE

According to an aspect of the present disclosure, a fuel storage tank for an automotive vehicle includes a receiver having perimeter walls defining an interior volume for storing liquid fuel, a number of anti-slosh bodies located within the receiver, and a fuel delivery module, also located within the receiver. At least one locator structure cooperates with the perimeter walls of the receiver to confine the anti-slosh bodies within a predetermined part of the interior volume.

According to another aspect of the present disclosure, at least one of the anti-slosh bodies includes a generally ovoidal shell having a hollow interior with a number of ports extending through the shell. The anti-slosh bodies reduce sloshing by absorbing fluid energy and by breaking the fluid motion into many small trajectory motions. The curvature exhibited by the ovoidal shells allows the moving fluid to flow smoothly around the anti-slosh bodies, absorbing the energy and rendering the sloshing much quieter. The baffle effect produced by the anti-slosh bodies is not merely planar, but available in all directions since the walls of the anti-slosh bodies present themselves to the flow in every direction. The ports extending through the shells of the anti-slosh bodies allow the free flow of fuel at low frequency so that the fuel indicator can respond more accurately. This also helps to prevent fuel starvation when the fuel level is low in the tank.

According to another aspect of the present disclosure, a locator structure for confining anti-slosh bodies within a predetermined part of the interior volume of a fuel tank may include a cage extending from a lower perimeter wall of the receiver to an upper perimeter wall of the receiver in a region circumscribing a fuel delivery module. Alternatively, a locator structure may include a linear element or a number of linear elements extending between the perimeter walls of the receiver, with the linear elements including, for example, a cable tensioned between at least two of the perimeter walls, with the cable extending through at least one of the anti-slosh bodies. The linear elements may also include a number of separators located between adjacent ones of the anti-slosh bodies. Such separators are ideally made of soft material which will prevent noises from being generated as the anti-slosh bodies move gently on the linear elements.

According to another aspect of the present disclosure, the anti-slosh bodies may include one or more generally ovoid-section hollow beams having an outer shell and extending between the perimeter walls of the fuel receiver, with each beam having a number of ports extending through the beam's outer shell, and with the locator structure in this case including a mount for attaching the beam to at least one of the perimeter walls of the receiver. As yet another alternative, the anti-slosh bodies may include one or more generally hemispherical hollow shells again having a number of ports extending therethrough, with the locator structure including a mount for attaching each hollow shell to an interior surface of one of the perimeter walls.

As used herein, the term “generally ovoidal” means a body having a smooth, curved surface, that could be curved onto itself. Special cases include bodies ranging from being egg shaped to spherical, with the spherical body being a special case of the ovoid in which the length of the ovoid matches the length of the widest part of the ovoid.

It is an advantage of a liquid storage tank according to the present disclosure that noise due to sloshing will be significantly reduced.

It is yet another advantage of a liquid fuel storage tank according to the present disclosure that fuel pump starvation may be avoided when operating with low fuel levels.

It is yet another advantage of a liquid fuel storage tank according to the present disclosure that the problems associated with excessive sloshing may be avoided even in the context of a plastic tank which normally presents problems for mounting interior baffles.

It is yet another advantage of a liquid storage tank according to the present disclosure that dynamic forces due to sloshing and fluid impact upon a tank's walls and internal plumbing, such as a fuel delivery module, will be reduced. This reduction in impact force will result in reduced stress and fatigue of tank walls, and tank mountings, such as straps, and tank internals.

It is yet another advantage of a liquid fuel storage tank according to the present disclosure that vent valves commonly used in fuel tanks will perform better in the absence of excessive sloshing.

Other advantages, as well as features of the present disclosure, will become apparent to the reader of this specification.

### BRIEF DESCRIPTION OF THE DRAWINGS

FIG. 1 is a plan view of a fuel storage tank according to an aspect of the present disclosure.

FIG. 2 is a side view of a fuel tank according to an aspect of the present disclosure.

FIG. 3 is a side view of a second fuel tank having ovoid and spherical anti-slosh bodies according to an aspect of the present disclosure.

FIG. 4 illustrates a fuel tank according to the present disclosure having a locator structure configured as a cage about a fuel sending device.

FIG. 5 illustrates a portion of the cage of FIG. 4.

FIG. 6 illustrates a base portion of a cage as shown in FIG. 4.

FIG. 7 illustrates a beam type of anti-slosh body in a plan view of a fuel tank.

FIG. 8 illustrates the beams of FIG. 7 in side view.

FIG. 9 illustrates a structure for securing the beams of FIGS. 7 and 8 to the wall of a liquid transport vessel.

FIG. 10 illustrates semi-hemispherical anti-slosh bodies according to an aspect of the present disclosure.

### DETAILED DESCRIPTION OF THE PREFERRED EMBODIMENTS

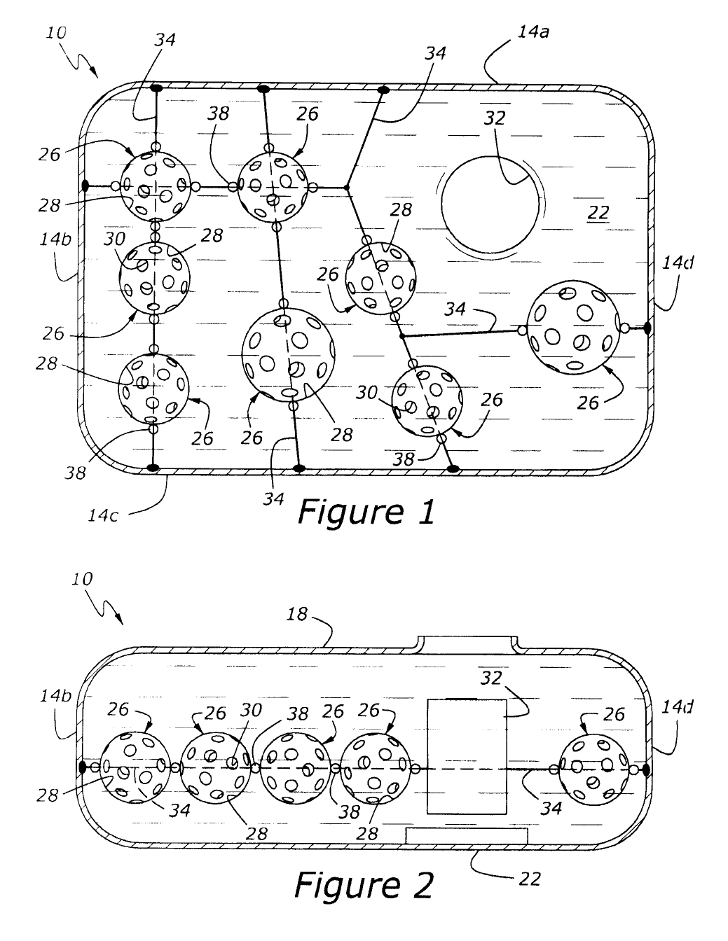

As shown in FIGS. 1 and 2, a fuel storage tank, 10, has a receiver defined by a number of perimeter walls including side walls 14a, 14b, 14c and 14d as well as upper perimeter wall 18 and lower perimeter wall 22. A number of generally ovoidal anti-slosh bodies, 26, are suspended within the receiver by a locator structure which cooperates with perimeter walls to confine anti-slosh bodies 26 within a predetermined part of the interior volume of the receiver. Each of the anti-slosh bodies 26 has a shell, 28, and a number of ports, 30, formed therein, to allow fuel to pass through anti-slosh bodies 26. Fuel tank 10 also includes a fuel delivery module, 32, which is shown in the various figures, and which includes an outlet (not shown) for fuel to leave tank 10 for transfer to the engine of a vehicle. Fuel delivery module 32 typically includes a fuel level sender, a pump, a filter, and various electrical and liquid connections for supplying fuel under pressure to a fuel line, (not shown). Anti-slosh bodies 26 may be formed from metallic, or non-metallic materials, or plastics, or composite materials, or yet other suitable materials which are known to those skilled in the art and which are compatible with automotive fuels or other liquids stored within tank 10. Those skilled in the art will further appreciate in view of this disclosure that the present liquid motion control system is useful with not only conventionally shaped tanks which may be rectangular, or cigar-shaped, or saddle-shaped, but also with tanks having free-form shapes dictated by the shape of the space available for housing the tank.

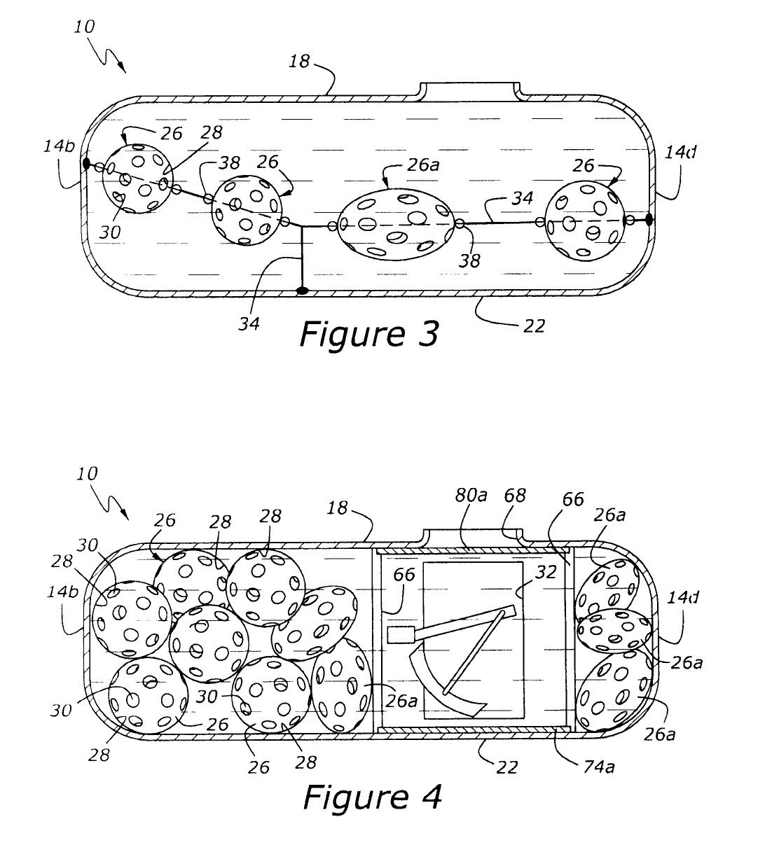

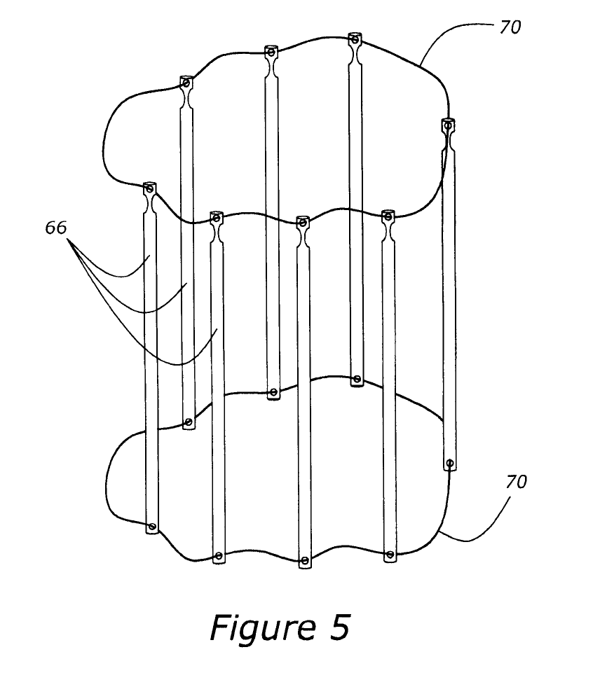

As is further shown in FIGS. 1, 2 and 3, anti-slosh bodies 26 may be suspended upon a locator structure including a linear element configured as a cable, 34, or series of cables, 34, tensioned between two or more perimeter walls, whether they be walls 14a-d or upper perimeter wall 18 and lower perimeter wall 22. As shown in FIG. 1, anti-slosh bodies 26 may be of different sizes and wholly spheroidal. However, as shown in FIGS. 3 and 4, anti-slosh bodies 26 may be strictly ovoidal, such as body 26a, or a mixture of ovoidal and spherical. In any event, cables 34 pass through shells 28 of generally ovoidal anti-slosh bodies 26, and cooperate with separators 38 to position anti-slosh bodies 26 as desired, to optimize the control of sloshing. Those skilled in the art will appreciate in view of this disclosure that this optimization may be achieved either empirically or analytically, or through a combination of both techniques. Separators 38 are preferably formed from a soft material so as to prevent noise caused by fuel moving about the tank and impacting shells 28 of anti-slosh bodies 26 upon the separators. Separators 38 are preferably heat staked or mounted in place in a fixed position upon cables 34, so as to maintain the desired positioning. Moreover, other types of separators will become apparent to those skilled in the art, in view of this disclosure.

As shown in FIG. 3, generally ovoidal anti-slosh bodies 26 do not need to be in the same horizontal plane and anti-slosh bodies of different shapes and sizes may be combined to achieve the desired control of sloshing.

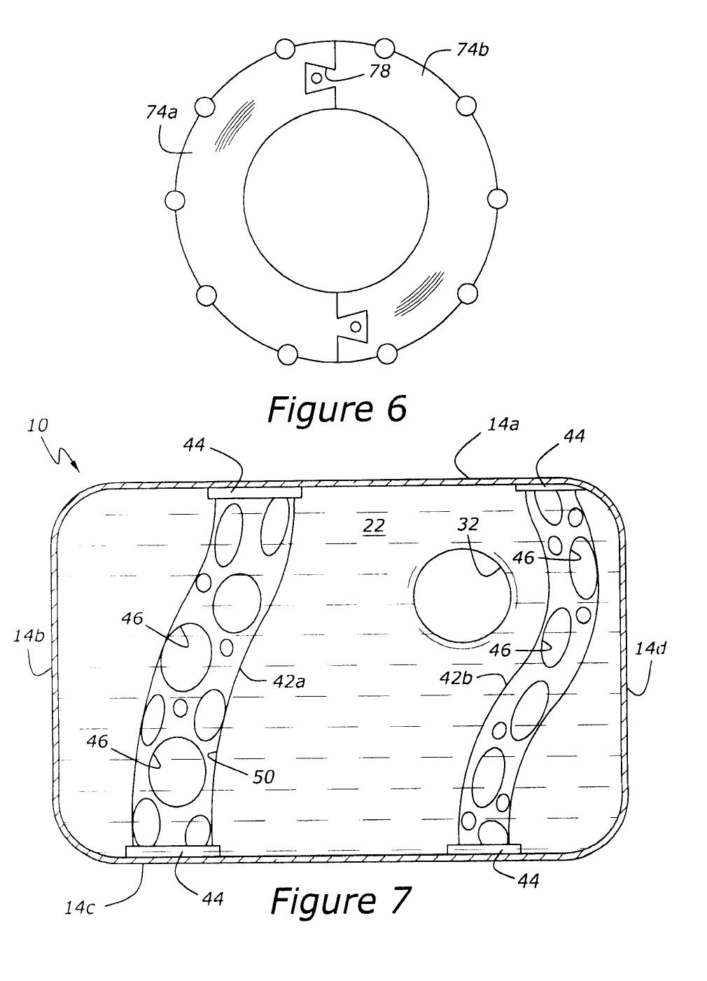

FIGS. 4, 5 and 6 illustrate an embodiment in which a locator structure includes a cage having a number of rods, 66, which are connected by a cable, 70, to allow their assembly into the tank in the manner shown in FIG. 4, wherein the base 74a and b shown in FIG. 6 as having a dovetail section 78, may be inserted into an opening in the fuel tank shown at 68 in FIG. 4, with rods 66 being maintained at locations about the perimeter of base 74a and b and a corresponding upper base 80a, having a similar two-piece configuration, so as to prevent generally ovoidal anti-slosh bodies 26 from encroaching upon fuel delivery module 32.

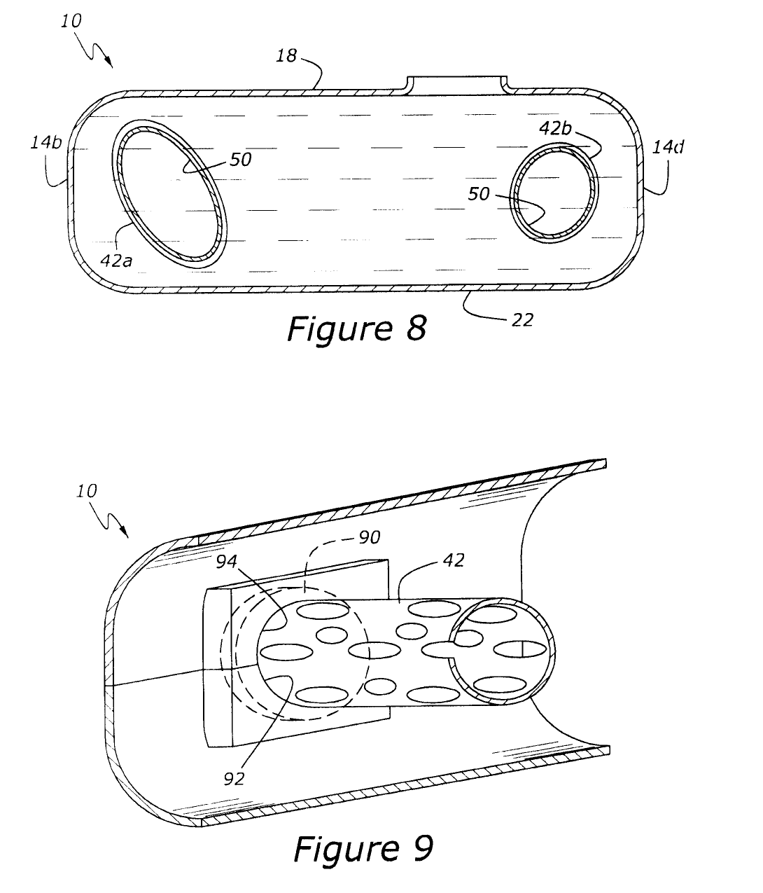

FIGS. 7 and 8 show beam-shaped anti-slosh bodies 42a and b which are ovoid section hollow beams, with each having an outer shell wall 50 and extending between perimeter walls as do the other types of anti-slosh bodies illustrated in this disclosure. Beam-shaped anti-slosh bodies 42 have ends, 44, which are bonded to perimeter walls 14a and 14c, as shown in FIG. 7. Beams 42a and 42b also have a number of ports, 46, which perform the function ascribed previously to the ports in the generally ovoidal shells described above. Beam-shaped anti-slosh bodies 42a and 42b also provide the added benefit of structural reinforcement and stiffness of tank 10.

FIG. 9 shows a preferred configuration for attaching beam-shaped anti-slosh bodies 42, in which each beam end has at each end an extended flange, 90, which is captured within a pocket defined by partial sockets 92 and 94 which are formed on opposing halves of tank 10. When tank 10 is assembled, flange 90 will be trapped within partial sockets 92 and 94.

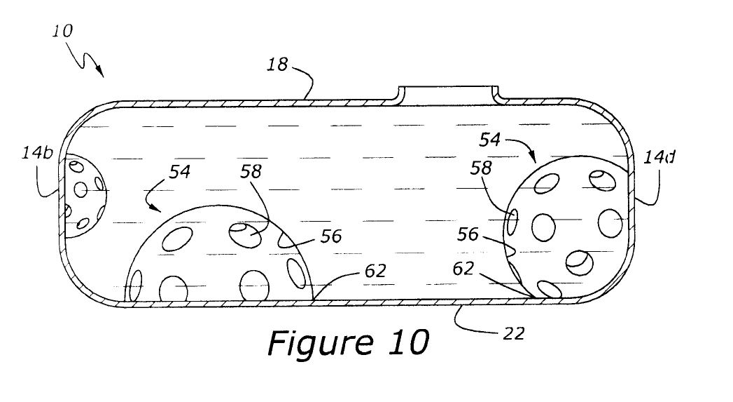

FIG. 10 illustrates an embodiment in which anti-slosh bodies include a number of smooth curvature hollow shells, illustrated as generally hemispherical hollow shells, 54, and having shell walls 56 and ports 58 extending therethrough, with a locator structure including a mounting surface, 62, for each of generally hemispherical hollow shells 54, so as to attach each hollow shell to an interior surface of one of the receiver's perimeter walls. Shells 54 follow the topography of the tank bottom.

The foregoing system has been described in accordance with the relevant legal standards, thus the description is exemplary rather than limiting in nature. Variations and modifications to the disclosed embodiments may become apparent to those skilled in the art and fall within the scope of the disclosure. Accordingly, the scope of legal protection can only be determined by studying the following claims.

What is claimed is:

1. A fuel storage tank for an automotive vehicle, comprising:
a receiver having a plurality of perimeter walls defining an interior volume for storing liquid fuel;
a plurality of anti-slosh bodies located within said receiver; and
at least one locator structure cooperating with said perimeter walls to confine said anti-slosh bodies within a predetermined part of said interior volume.

2. A fuel storage tank according to claim 1, wherein at least one of said anti-slosh bodies comprises a generally ovoidal shell having a hollow interior, with a plurality of ports extending through the shell.

3. A fuel storage tank according to claim 2, wherein said at least one locator structure comprises a cage extending from a lower perimeter wall of said receiver to an upper perimeter wall of said receiver in a region circumscribing a fuel delivery module.

4. A fuel storage tank according to claim 2, wherein said at least one locator structure comprises a linear element extending between a plurality of said perimeter walls.

5. A fuel storage tank according to claim 4, wherein said linear element comprises a cable tensioned between at least two of said perimeter walls, with said cable extending through at least one of said anti-slosh bodies.

6. A fuel storage tank according to claim 4, wherein said linear element extends through a plurality of said anti-slosh bodies.

7. A fuel storage tank according to claim 6, wherein said linear element further comprises a plurality of separators, with at least one of said separators being located upon said linear element between adjacent ones of said anti-slosh bodies.

8. A fuel storage tank according to claim 1, wherein said anti-slosh bodies comprise at least one generally ovoid-sectioned hollow beam having an outer shell and extending between a plurality of said perimeter walls, with said beam having a plurality of ports extending through the outer shell, and with said at least one locator structure comprising a mount for attaching said beam to at least one of said perimeter walls.

9. A fuel storage tank according to claim 1, wherein said anti-slosh bodies comprise at least one generally generally hemispherical hollow shell having a plurality of ports extending therethrough, with said at least one locator structure comprising a mount for attaching said hollow shell to an interior surface of at least one of said perimeter walls.

10. A fuel storage tank for an automotive vehicle, comprising:
a receiver having a plurality of perimeter walls defining an interior volume for storing liquid fuel;
a plurality of hollow, generally ovoid, anti-slosh bodies located within said receiver, with said bodies having ported outer shells allowing fuel to freely flow through said bodies; and
a locator system cooperating with said perimeter walls to suspend at least some of said anti-slosh bodies within a predetermined region of said interior volume.

11. A fuel storage tank according to claim 10, wherein said locator system comprises at least one cable extending between at least two of said perimeter walls, with said cable extending through said suspended anti-slosh bodies.

12. A liquid transport tank, comprising:
a receiver having a plurality of perimeter walls defining an interior volume for storing liquid;
a plurality of anti-slosh bodies located within said receiver; and
at least one locator structure cooperating with said perimeter walls to confine said anti-slosh bodies within a predetermined part of said interior volume.

13. A liquid transport tank according to claim 12, wherein at least one of said anti-slosh bodies comprises a generally ovoidal shell having a hollow interior, with a plurality of ports extending through the shell.

14. A liquid transport tank according to claim 12, wherein said anti-slosh bodies comprise at least one generally ovoid-sectioned hollow beam having an outer shell and extending between a plurality of said perimeter walls, with said beam having a plurality of ports extending through the outer shell, and with said at least one locator structure comprising a mount for attaching said beam to at least one of said perimeter walls.
